(19) United States
(12) Patent Application Publication
(10) Pub. No.: US 2023/0328084 A1
(43) Pub. Date: Oct. 12, 2023

(54) SYSTEMS AND METHODS FOR NEAR REAL-TIME RISK SCORE GENERATION

(71) Applicant: MICRO FOCUS LLC, SANTA CLARA, CA (US)

(72) Inventors: Asad Narayanan, Ottawa (CA); Josh Christopher Tyler Mahonin, Ottawa (CA); Venkatesh HariRama Subbu, Ottawa (CA); Maria Pospelova, Ottawa (CA); Hari Manassery Koduvely, Ottawa (CA)

(73) Assignee: MICRO FOCUS LLC, SANTA CLARA, CA (US)

(21) Appl. No.: 17/719,031

(22) Filed: Apr. 12, 2022

(51) Int. Cl. H04L 9/40

(52) U.S. Cl. CPC H04L 63/1425

(57) ABSTRACT

Embodiments of the present disclosure provide a system for generating risk scores in near real-time. The system includes a processor and a memory coupled with and readable by the processor and storing therein a set of instructions. When executed by the processor, the processor is caused to generate risk scores in near real-time by receiving near real-time application events associated with an application in near real-time and identifying anomalies from the near real-time application events. The processor is further caused to generate risk scores in near real-time by generating an intermediate near real-time risk score for the identified anomalies and combining the intermediate near real-time risk score with a batch risk score generated from a batch process executed prior to receiving the near real-time application events to generate a near real-time risk score.

### FIELD

The present disclosure relates generally to systems and methods for generating risk scores in near real-time and particularly to systems and methods for training models to identify anomalies used for generating risk scores in near real-time for entity authentication or alert notification.

### BACKGROUND

Conventional “Big Data” anomaly detection models perform batch training and batch inferences on entities. As used herein, entities typically refer to users or machines (e.g., users, machines, IP addresses, share drives, projects/repositories, email, web domain, process, device, printers, resources, etc.). Risks associated with these entities are computed based on anomalies predicted only after the batch inferences have been performed. For the conventional “Big Data” anomaly detection models, scenarios such as entity authentication require additional near real-time predictions and risk score computations. Conventional approaches for addressing anomaly detection for cyber-attacks on businesses and banking systems or for abnormal behavior are limited since near real-time predictions and risk score computations are not used. Therefore, there is a need for training models to identify anomalies used for generating risk scores in near real-time for entity authentication or alert notification.

### SUMMARY

Embodiments of the present disclosure provide systems, methods and non-transitory computer-readable mediums for generating risk scores in near real-time. According to one embodiment of the present disclosure, a system includes a processor and a memory coupled with and readable by the processor and storing therein a set of instructions. When executed by the processor, the processor is caused to generate risk scores in near real-time by receiving near real-time application events associated with an application in near real-time and identifying anomalies from the near real-time application events. The processor is further caused to generate risk scores in near real-time by generating an intermediate near real-time risk score for the identified anomalies and combining the intermediate near real-time risk score with a batch risk score generated from a batch process executed prior to receiving the near real-time application events to generate a near real-time risk score.

Aspects of the above system include wherein identifying anomalies from the near real-time application events further includes extracting features from each near real-time application at one time.

Aspects of the above system include wherein identifying anomalies from the near real-time application events further includes using models trained from extracted features from application events processed during the batch process.

Aspects of the above system include wherein the extracted features from application events processed during the batch process include features extracted from each application event at one time and features extracted from multiple application events at one time.

Aspects of the above system include wherein the identified anomalies include volumetric anomalies and point-in-time anomalies.

Aspects of the above system include wherein some of the volumetric anomalies are subject to a time dependent decay in value.

Aspects of the above system include wherein some of the point-in-time anomalies are subject to a time dependent decay in value.

Aspects of the above system include further comparing the near real-time risk score with a predetermined threshold and initiating an action if the near real-time risk score exceeds the predetermined threshold.

Aspects of the above system include wherein initiating an action if the near real-time risk score exceeds the predetermined threshold further includes requesting additional information for entity authentication.

Aspects of the above system include wherein initiating an action if the near real-time risk score exceeds the predetermined threshold further includes requesting a detailed investigation in response to an alert notification.

Aspects of the above system include wherein initiating an action if the near real-time risk score exceeds the predetermined threshold further includes displaying a graphical representation of the near real-time risk score.

According to one embodiment of the present disclosure, a method for generating risk scores in near real-time includes receiving, by a data analytics in near real-time system, near real-time application events associated with an application of the data analytics in near real-time system in near real-time and identifying, by the data analytics in near real-time system, anomalies from the near real-time application events. The method further includes generating, by the data analytics in near real-time system, an intermediate near real-time risk score for the identified anomalies and combining, by the data analytics in near real-time system, the intermediate near real-time risk score with a batch risk score generated from a batch process executed prior to receiving the near real-time application events to generate a near real-time risk score.

Aspects of the above method include wherein identifying anomalies from the near real-time application events further includes extracting, by the data analytics in near real-time system, features from each near real-time application at one time.

Aspects of the above method include wherein identifying anomalies from the near real-time application events further includes using, by the data analytics in near real-time system, models trained from extracted features from application events processed during the batch process.

Aspects of the above method include wherein the extracted features from application events processed during the batch process include features extracted from each application event at one time and features extracted from multiple application events at one time.

Aspects of the above method include wherein the identified anomalies include volumetric anomalies and point-in-time anomalies.

Aspects of the above method include wherein some of the volumetric anomalies are subject to a time dependent decay in value.

Aspects of the above method include wherein some of the point-in-time anomalies are subject to a time dependent decay in value.

Aspects of the above method further include comparing, by the data analytics in near real-time system, the near real-time risk score with a predetermined threshold and initiating, by the data analytics in near real-time system, an action if the near real-time risk score exceeds the predetermined threshold.

According to one embodiment of the present disclosure, a non-transitory, computer readable medium comprising a set of instructions stored therein which when executed by a processor, causes the processor to generate risk scores in near real-time by receiving near real-time application events associated with an application in near real-time, identifying anomalies from the near real-time application events, generating an intermediate near real-time risk score for the identified anomalies and combining the intermediate near real-time risk score with a batch risk score generated from a batch process executed prior to receiving the near real-time application events to generate a near real-time risk score.

These and other needs are addressed by the various embodiments and configurations of the present disclosure. The present disclosure can provide a number of advantages depending on the particular configuration. These and other advantages will be apparent from the disclosure contained herein.

The phrases “at least one”, “one or more”, “or”, and “and/or” are open-ended expressions that are both conjunctive and disjunctive in operation. For example, each of the expressions “at least one of A, B and C”, “at least one of A, B or C”, “one or more of A, B and C”, “one or more of A, B or C”, “A, B and/or C”, and “A, B or C” means A alone, B alone, C alone, A and B together, A and C together, B and C together or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit”, “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device. For example, the computer readable medium (s) may be non-transitory or non-volatile medium, such as a magnetic disk or solid-state non-volatile memory or volatile medium such as RAM.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine”, “calculate” and “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1 is a block diagram illustrating elements of an example computing environment in which embodiments of the present disclosure may be implemented.

FIG. 2 is a block diagram illustrating elements of an example computing system in which embodiments of the present disclosure may be implemented.

FIG. 3A is a block diagram illustrating elements of an example computing environment including an example data analytics in near real-time system in which embodiments of the present disclosure may be implemented.

FIG. 3B is a block diagram illustrating example elements for batch components included in an example data analytics in near real-time system in which embodiments of the present disclosure may be implemented.

FIG. 3C is a block diagram illustrating example elements for near real-time (NRT) components included in an example data analytics in near real-time system in which embodiments of the present disclosure may be implemented

FIG. 4 is a block diagram illustrating elements of an example data analytics in near real-time system architecture according to embodiments of the present disclosure.

FIG. 5A illustrates an example application events table generated according to embodiments of the present disclosure.

FIG. 5B illustrates an example of features extracted from an individual application event according to embodiments of the present disclosure.

FIG. 5C illustrates an example of features extracted from multiple application events according to embodiments of the present disclosure.

FIG. 6 is a graph illustrating an example NRT risk score engine for an example data analytics in near real-time system according to embodiments of the present disclosure.

FIG. 7 is a flowchart illustrating an example method of near real-time risk score generation for entity authentication or alert notification according to embodiments of the present disclosure.

FIG. 8 is a flowchart illustrating an example method of near real-time risk generation according to embodiments of the present disclosure.

FIG. 9 is an example graphical user interface (GUI) associated with an example data analytics in near real-time system according to embodiments of the present disclosure.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

Embodiments of the present disclosure are directed to systems and methods for training models to identify anomalies used for generating risk scores in near real-time (e.g., in a matter of seconds) for entity authentication or alert notification. The systems and methods according to embodiments of the present disclosure include batch components for generating batch risk scores and near real-time (NRT) components for generating NRT risk scores. For any given inquiry regarding entity authentication or alert notification, the batch risk score is combined with an intermediate NRT risk score to generate a NRT risk score. The batch components receive events (e.g., data regarding an entity's browser histories, data regarding an entity's location, data regarding the time an entity uses an application, etc.) during a batch process. As defined herein, a batch refers to any interval of time (e.g., every 24 hours). Features extracted from the events during the batch process are used to train models. The trained models are used to identify anomalies during the batch process. The identified anomalies are used to generate a batch risk score for an entity during the batch process.

The NRT components also receive events, but these events are received in near real-time. Features extracted from the NRT events, along with the trained models from the batch components are used to identify NRT anomalies. The identified NRT anomalies are used to compute an intermediate NRT risk score. This intermediate NRT risk score is combined with the batch risk score to generate a NRT risk score. The NRT risk score is compared with a predetermined threshold to determine if the NRT risk score exceeds the predetermined threshold. If the NRT risk score exceeds the predetermined threshold, an entity authentication system may determine if additional checks are warranted, or an alert notification system may determine if a more detailed investigation is required.

According to embodiments of the present disclosure, the batch components which may be incorporated into a batch processing system, are provided for processing large volumes of data and training models. In other words, the batch components are provided for training, making inferences and generating risk scores during batch processes (e.g., through job scheduling for specific times of the day). The NRT components which may be incorporated into a NRT processing system, are used for making inferences and generating risk scores in near real-time (i.e., within a short period of time). According to embodiments of the present disclosure, one or more algorithms, for example, are used to train the models based on the extracted features to generate patterns used for anomaly identification.

Generally, a risk R at any time t, may be define as R(t). The risk includes risk contributions from point-in-time anomalies and risk contributions from volumetric anomalies. Volumetric anomalies, by definition, correspond to anomalies generated when aggregated features (e.g., the number of certain events, sequence of commands, time of activity, etc.) deviate from the baseline behavior. Generally, there are two types of volumetric anomalies: a compared to self-volumetric anomaly and a compared to others volumetric anomaly. The compared to self-volumetric anomaly occurs when a count of a certain type of event (e.g., the number of times a server is accessed) in a certain window of time (e.g., hour or day) for a particular entity is abnormally high as compared to a baseline count for the certain type of event, in the certain window of time for the particular entity. The compared to others volumetric anomaly occurs when the count of a certain type of event (e.g., the number of times a server is accessed) in a certain window of time (e.g., hour or day) for a particular entity is abnormally high as compared to an average baseline count for the certain type of event, in the certain window of time for all entities similar to the particular entity).

Point-in-time anomalies refer to anomalies that can be identified on a single event. Conversely, volumetric anomalies are anomalies that are identified on aggregation of events over a defined time-period that do not happen frequently. Computing the contributions from volumetric anomalies for an anomaly detecting system include querying all the volumetric anomalies that arrived since the last completed hour for the anomaly detecting system. For example, if the current time is 10:20 a.m., all the recent anomalies produced since 10:00 a.m. would be queried. Calculating the probability value associated with each anomaly is scaled using a factor computed from the importance of each component of an event and the weight of each anomaly type. In this case, only volumetric anomalies generated since the previous completed hour are computed. However, at this point, since the cumulative sum of a risk for an entity is calculated across time, there are some changes to be made for near real-time scenarios. This is because in near real-time scenarios, it is possible that there is a delay between an actual occurrence of an event and its arrival to the anomaly detection system.

The present disclosure provides a number of advantages over the conventional art. When the risk score is computed in a batch process, according to embodiments of the present disclosure, the delay problem is alleviated. To address delayed anomalies, the logic for computing the cumulative sum changes. Instead of recomputing the previous risk score corresponding to the actual time bucket for the delayed anomalies, the delayed anomalies are added to the current time bucket but with a delay corresponding to the time difference between the current time bucket and the time bucket of the actual occurrence time of the event. This form of a decay function is identical to modifying the previous risk scores by incorporating delayed anomalies. The decay function is used in calculating both the batch risk scores and the NRT risk scores. As used herein, time-bucket refers to segments of the time analyzed together (e.g., hour, 30 minutes, 15 minutes, 5 minutes, etc.). If an anomaly from two hours before arrives at the present time, a decay corresponding to two hours is applied to the anomaly before it is added to the current entity risk.

By incorporating the decay function to compute the risk scores, a more efficient data analysis system that can compute risk scores in near real-time is achieved in comparison to conventional data analysis systems. The described embodiments of the present disclosure make the existing hardware and software components more efficient while reducing the overall cost to implement the generation of risk scores in near real-time which was previously impossible. These and other advantages will be apparent from the disclosure contained herein.

In addition, processes for generating risk scores in near real-time herein are designed to support application events (e.g., data regarding an entity's browser histories, data regarding an entity's location, data regarding the time an entity uses an application, financial transactions, etc.) in near real-time. Being able to support application events in near real-time is clearly something that cannot be done practically using a mental process. Instead, the processes for generating risk scores in near real-time described herein will only work in a computerized environment.

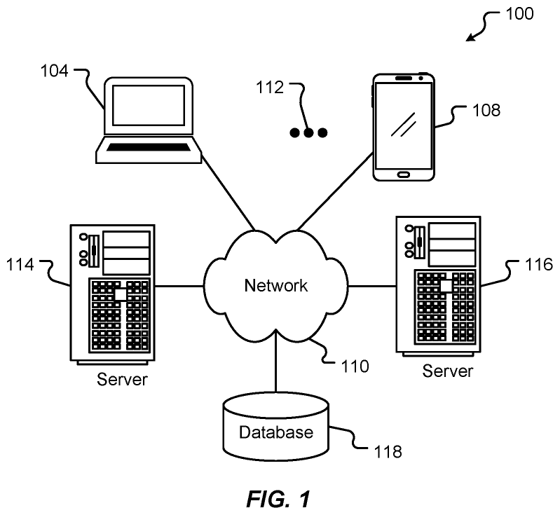

FIG. 1 is a block diagram illustrating elements of an example computing environment 100 in which embodiments of the present disclosure may be implemented. More specifically, this example illustrates a computing environment 100 that may function as the servers, user computers, or other systems provided and described herein. The environment 100 includes one or more user computers, or computing devices, such as a computer 104, a communication device 108, and/or more devices 112. The devices 104, 108, 112 may include general purpose personal computers (including, merely by way of example, personal computers, and/or laptop computers running various versions of Microsoft Corp.'s Windows® and/or Apple Corp.'s Macintosh® operating systems) and/or workstation computers running any of a variety of commercially-available UNIX® or UNIX-like operating systems. These devices 104, 108, 112 may also have any of a variety of applications, including for example, database client and/or server applications, and web browser applications. Alternatively, the devices 104, 108, 112 may be any other electronic device, such as a thin-client computer, Internet-enabled mobile telephone, and/or personal digital assistant, capable of communicating via a network 110 and/or playing audio, displaying images, etc. Although the example computer environment 100 is shown with two devices, any number of user computers or computing devices may be supported.

Environment 100 further includes a network 110. The network 110 may can be any type of network familiar to those skilled in the art that can support data communications using any of a variety of commercially-available protocols, including without limitation Session Initiation Protocol (SIP), Transmission Control Protocol/Internet Protocol (TCP/IP), Systems Network Architecture (SNA), Internetwork Packet Exchange (IPX), AppleTalk, and the like. Merely by way of example, the network 110 maybe a Local Area Network (LAN), such as an Ethernet network, a Token-Ring network and/or the like; a wide-area network; a virtual network, including without limitation a Virtual Private Network (VPN); the Internet; an intranet; an extranet; a Public Switched Telephone Network (PSTN); an infra-red network; a wireless network (e.g., a network operating under any of the IEEE 802.9 suite of protocols, the Bluetooth® protocol known in the art, and/or any other wireless protocol); and/or any combination of these and/or other networks.

The environment 100 may also include one or more servers 114, 116. For example, the servers 114 and 116 may comprise build servers, which may be used to test webpage layout on various screen sizes via the device 104, 108, 112. The servers 114 and 116 can be running an operating system including any of those discussed above, as well as any commercially available server operating systems. The servers 114 and 116 may also include one or more file and/or application servers, which can, in addition to an operating system, include one or more applications accessible by a client running on one or more of the devices 104, 108, 112. The server(s) 114 and/or 116 may be one or more general purpose computers capable of executing programs or scripts in response to the computers 104, 108, 112. As one example, the servers 114 and 116, may execute one or more automated tests. The automated tests may be implemented as one or more scripts or programs written in any programming language, such as Java™, C, C#®, or C++, and/or any scripting language, such as Perl, Python, or Tool Command Language (TCL), as well as combinations of any programming/scripting languages. The server(s) 114 and 116 may also include database servers, including without limitation those commercially available from Oracle®, Microsoft®, Sybase®, IBM® and the like, which can process requests from database clients running on the device 104, 108, 112.

The server 114 and/or 116 may transfer the generated webpage layout and/or data related to the same to the device 104, 108, 112. Although for ease of description, FIG. 1 illustrates two servers 114 and 116, those skilled in the art will recognize that the functions described with respect to servers 114, 116 may be performed by a single server and/or a plurality of specialized servers, depending on implementation-specific needs and parameters. The computer systems 104, 108, 112, and servers 114 116 may function as the system, devices, or components described herein.

The environment 100 may also include a database 118. The database 118 may reside in a variety of locations. By way of example, database 118 may reside on a storage medium local to (and/or resident in) one or more of the computers/servers 104, 108, 112, 114, 116. Alternatively, it may be remote from any or all of the computers/servers 104, 108, 112, 114, 116, and in communication (e.g., via the network 110) with one or more of these. The database 118 may reside in a Storage-Area Network (SAN) familiar to those skilled in the art. Similarly, any necessary files for performing the functions attributed to the computers/servers 104, 108, 112, 114, 116 may be stored locally on the respective computer/server and/or remotely, as appropriate. The database 118 may be used to store webpage layout data (e.g., respective locations of a plurality of elements), alerts, etc.

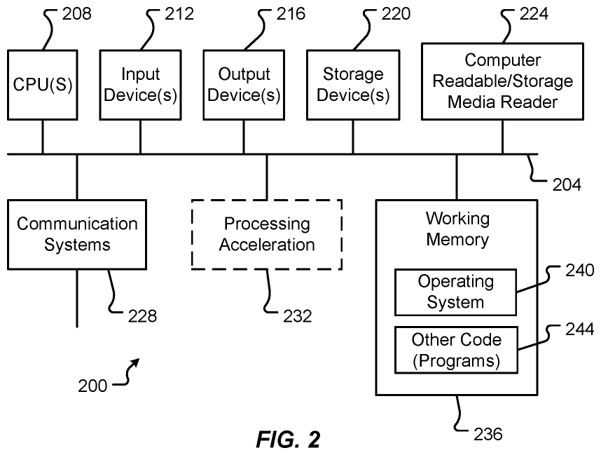

FIG. 2 is a block diagram illustrating elements of an example computing system 200 in which embodiments of the present disclosure may be implemented. More specifically, this example illustrates one embodiment of a computer system 200 upon which the servers, computing devices, or other systems or components described above may be deployed or executed. The computer system 200 is shown comprising hardware elements that may be electrically coupled via a bus 204. The hardware elements may include one or more Central Processing Units (CPUs) 208; one or more input devices 212 (e.g., a mouse, a keyboard, etc.); and one or more output devices 216 (e.g., a display device, a printer, etc.). The computer system 200 may also include one or more storage devices 220. By way of example, storage device(s) 220 may be disk drives, optical storage devices, solid-state storage devices such as a Random-Access Memory (RAM) and/or a Read-Only Memory (ROM), which can be programmable, flash-updateable and/or the like.

The computer system 200 may additionally include a computer-readable storage media reader 224; a communications system 228 (e.g., a modem, a network card (wireless or wired), an infra-red communication device, etc.); and working memory 236, which may include RAM and ROM devices as described above. The computer system 200 may also include a processing acceleration unit 232, which can include a Digital Signal Processor (DSP), a special-purpose processor, and/or the like.

The computer-readable storage media reader 224 can further be connected to a computer-readable storage medium, together (and, optionally, in combination with storage device(s) 220) comprehensively representing remote, local, fixed, and/or removable storage devices plus storage media for temporarily and/or more permanently containing computer-readable information. The communications system 228 may permit data to be exchanged with a network and/or any other computer described above with respect to the computer environments described herein. Moreover, as disclosed herein, the term “storage medium” may represent one or more devices for storing data, including ROM, RAM, magnetic RAM, core memory, magnetic disk storage mediums, optical storage mediums, flash memory devices and/or other machine-readable mediums for storing information.

The computer system 200 may also comprise software elements, shown as being currently located within a working memory 236, including an operating system 240 and/or other code 244. It should be appreciated that alternate embodiments of a computer system 200 may have numerous variations from that described above. For example, customized hardware might also be used and/or particular elements might be implemented in hardware, software (including portable software, such as applets), or both. Further, connection to other computers such as network input/output devices may be employed.

Examples of the processors 208 as described herein may include, but are not limited to, at least one of Qualcomm® Snapdragon® 800 and 801, Qualcomm® Snapdragon® 620 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-processors, ARM® Cortex-A and ARM926EJ-S™ processors, other industry-equivalent processors, and may perform computational functions using any known or future-developed standard, instruction set, libraries, and/or architecture.

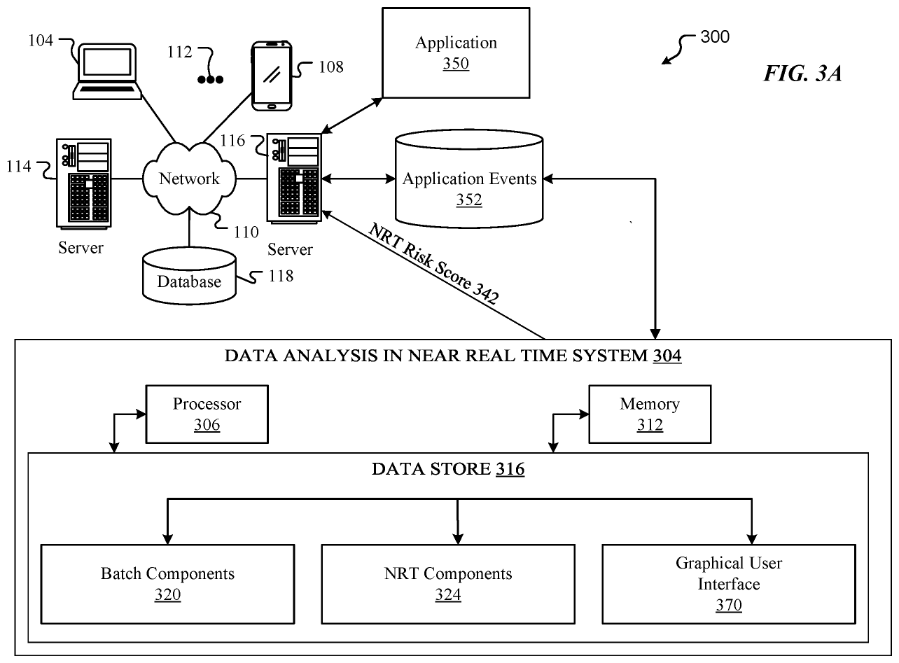

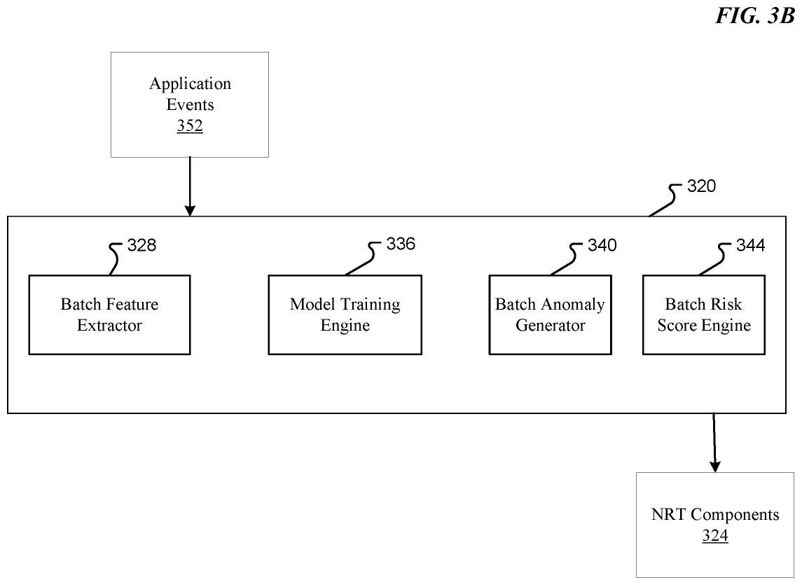

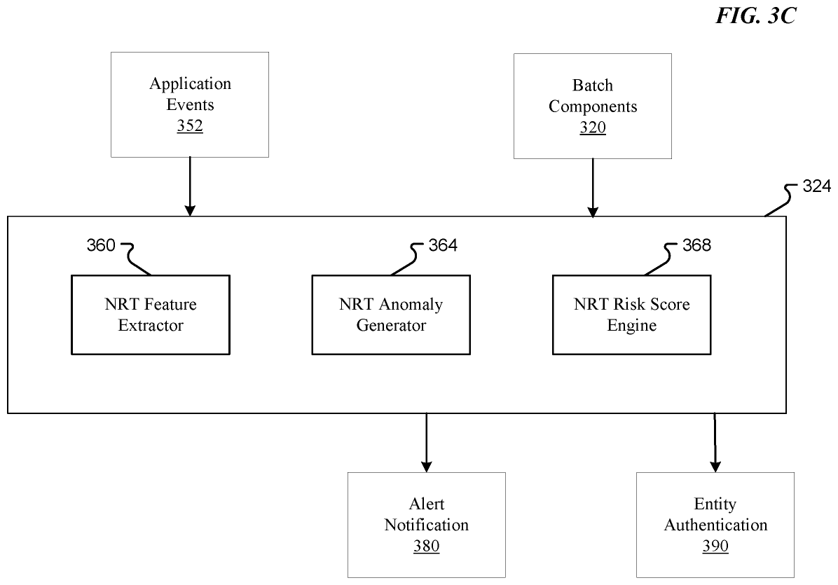

FIG. 3A is a block diagram illustrating elements of an example computing environment 300 including an example data analytics in near real-time system 304 in which embodiments of the present disclosure may be implemented. The computing environment 300 includes similar elements such as the computers/servers 104, 108, 112, 114, 116, the network 110 and the database 118 illustrated in FIG. 1. Since these elements are discussed in FIG. 1, a description of these elements will be omitted. The computing environment 300 further includes an application 350, application events 352 and the data analytics in near real-time system 304. The application 350 may include, for example application(s) utilized by users of the computers 104, 108, 112. Such application(s) may include financial/banking applications, medical applications, etc. The application events 352 may include data regarding an entity's activities with respect to the application 350. For example, application events 352 may include an entity's location when activating the application 350 (e.g., a time of use for the application (e.g., the time the entity activates the application(s)), a duration of time for the use of the application (e.g., a length of time the entity activates the application(s)), a browser used for the application (e.g., the browser(s) used in activating the application(s)), etc.

Moreover, application events 352 can include information or metadata regarding the various operations that occur during the course of execution of the application 350. This can include entity interaction data from one or more of the computer(s) 104, 108, 112, metadata of the operations which are carried out by the application 350 including their date and time of execution, the resources accessed, the information regarding the success or failure of operations and the like. For example, the application events 352 for a web-based application may include various types of data such as but not limited to site confidence monitoring data logs, application logs, access logs, and other data logs. As used herein, log data refers to any collection of telemetry events that track activities of entities which are important from a security perspective. Examples of log data, may include, but are not limited to authentication logs, web poxy logs, project repository logs, email logs, Virtual Private Network (VPN) logs, etc. It can be appreciated that the application events 352 may be recorded and stored on a data store in the same location as the server(s) 114, 116 which executes the application 350 or other machines which may be remote from the server(s) 114, 116.

At least one of the servers 114, 116 executes the application 350 for example a web-based, e-commerce application that is accessed by the plurality of computers 104, 108, 112 via the network 110. In one example embodiment of the present disclosure, the application 350 may be a series of processor-executable instructions stored in a processor-readable storage medium on the server(s) 114, 116 and being executed by one or more processors within the server(s) 114, 116 and/or other devices. The series of processor-executable instructions included in the application 350 may enable the application 350 to receive and process inputs and provide outputs based on the processing of the inputs. The inputs may be received manually from users or from other applications, external machinery, databases and the like.

Certain elements may be discussed below with respect to the web-based, e-Commerce application only by the way of illustration but not limitation. It can be appreciated that various other types of applications such as but not limited to, telecommunication applications facilitating network communications between various devices, data access and management applications, medical applications, financial applications and the like may be monitored by the data analytics in near real-time system 304 in accordance with examples discussed herein.

The various operations that occur during the normal execution of the application 350 such as but not limited to, accessing the application 350 by the computers 1047 108, 112, the user requests fulfilled by the application 350, any changes to database 118 made by the application 350, the success or failure of the various interactions from one or more of the computers 104, 108, 112 are recorded in the application events 352. The application events 352 may be temporarily cached on the server(s) 114, 116 and may be offloaded to a memory 312 of the data analytics in near real-time system 304 at predetermined times. The application events 352 therefore include valuable data on the operation of the application 350.

Examples of the data analytics in near real-time system 304 discussed herein are configured to process the application events 352 and train models in order to generate risk scores associated with one or more entities. The trained models are used to identify anomalies. Anomalies may include volumetric anomalies and point-in-time anomalies. It can be appreciated that the data analytics in near real-time system 304 can be executed by the server(s) 114, 116 that executes the application 350 or by another machine with the processor 306 and the data store 316. The data analytics in near real-time system 304 may be at the same location as the server(s) 114, 116 or it may be located remotely from the server(s) 114, 116. In an example embodiment of the present disclosure, the application events 352 may also be located remotely from the data analytics in near real-time system 304. In fact, the data analytics in near real-time system 304 may thus be connected to a plurality of machines each of which may be executing a different application for which the data analytics in near real-time system 304 executes respective trained model(s) to identify anomalies used to generate near real-time risk scores. For the purposes of brevity, the below description will be confined to one application although the features discussed herein are equally applicable when the data analytics in near real-time system 304 is executing a plurality of respective trained models corresponding to a plurality of applications.

The data analytics in near real-time system 304 includes at least processor 306, memory 312 and data store 316. Data store 316 generally includes batch components 320, near real-time (NRT) components and a graphical user interface (GUI) 370. The batch components 320 as discussed in greater detail in FIG. 3B are used to generate batch risk scores. The NRT components 324 are used to generate NRT risk scores as discussed in greater detail in FIG. 3C. Although the batch components 320 and the NRT components 324 are illustrated as being within the same system, these components can be provided remote from each other and distributed within the computing environment 300 without departing from the spirit and scope of the present disclosure. The GUI 370 included in the data analytics in near real-time system 304 is configured to provide graphical representations for the batch anomalies, the NRT anomalies, the batch risk scores and the NRT risk scores. Moreover, the GUI 370 provides a platform for security analysis to perform the following: view top risk entities in near real-time; explore the anomalies generated by the trained models; and trace anomalies and risk scores to the data (e.g., application events 352) that triggered the anomalies.

FIG. 3B is a block diagram illustrating example elements for the batch components 320 included in the example data analytics in near real-time system 304 in which embodiments of the present disclosure may be implemented. Batch components 320 include batch feature extractor 328, model training engine 336, batch anomaly generator 340 and batch risk score engine 344. The batch feature extractor 328 receives the application events 352 and includes processor-executable instructions to access the application events 352 from the application 350. These application events 352 are processed by the batch components 320 during a batch process. As used herein, application events 352 may include records detailing an entity's activities. Additionally, or alternatively, application events 352 may include interaction data from one or more of the computer(s) 104, 108, 112, metadata of the operations Which are carried out by the application 350 including their date and time of execution, the resources accessed, the information regarding the success or failure of operations and the like.

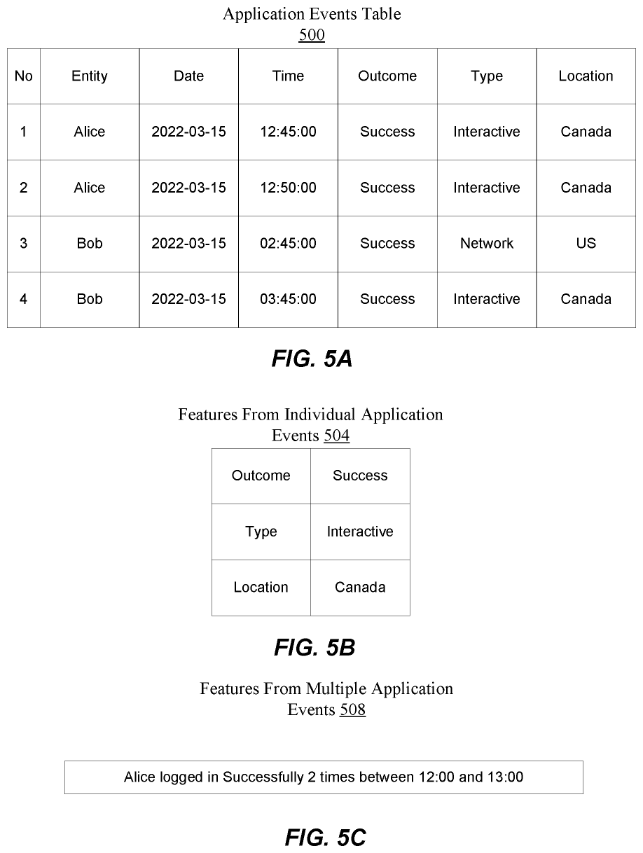

For example, FIG. 5A illustrates an example application events table 500 generated according to embodiments of the present disclosure. As illustrated in FIG. 5A, the application events table 500 includes attributes provided in columns and application events provided in rows. The attributes of the application events table 500 include an application event number, an application event date, an application event time, an application event outcome, an application event logon type and an application event location. As illustrated in the application events table 500, there are four application events recorded. Application event No. 1 includes the following information: Entity=Alice; Date=2022-03-15; Time=12:45:00; Outcome=Success; Type=Interactive; and Location=Canada (i.e., Alice successfully logged in in Canada using an interactive logon at 12:45 on Mar. 15, 2022). Application event No. 2 includes the following information: Entity=Alice; Date=2022-03-15; Time=12:50:00; Outcome=Success; Type=Interactive; and Location=Canada (i.e., Alice successfully logged in in Canada using an interactive logon at 12:50 on Mar. 15, 2022). Application event No. 3 includes the following information: Entity=Bob; Date=2022-03-15; Time=02:45:00; Outcome=Success; Type=Network; and Location=U.S (i.e., Bob successfully logged in in the U.S. using a network logon at 2:45 on Mar. 15, 2022). Application event No. 4 includes the following information: Entity=Bob; Date=2022-03-15; Time=03:45:00; Outcome=Success; Type=Interactive; and Location=Canada (i.e., Bob successfully logged in in Canada using an interactive logon at 3:45 on Mar. 15, 2022).

According to embodiments of the present disclosure and referring back to FIG. 3B, the batch feature extractor 328 receives the application events 352 (e.g., application events Nos. 1-4) and processes the application events 352 by extracting features from individual application events 352 and extracting features from multiple application events 352. FIG. 5B illustrates an example of features extracted from an individual application event 504 according to embodiments of the present disclosure. As illustrated in FIG. 5B, the features “Success,” “Interactive” and “Canada” for the attributes “Outcome,” “Type” and “Location,” respectively, are extracted from application event No. 1 illustrated in FIG. 5A by the batch feature extractor 328. The batch feature extractor 328 also extracts features from multiple application events 352. Referring now to FIG. 5C, which illustrates an example of features extracted from multiple application events 508 according to embodiments of the present disclosure, the batch feature extractor 328 extracts features from the application events 352 (e.g., application event Nos. 1 and 2). As illustrated in FIG. 5C, “Alice logged in successfully two (2) times between 12:00 and 13:00” are the features extracted from application events 352 (e.g., application event Nos. 1 and 2) illustrated in FIG. 5A.

Referring back to FIG. 3B, the extracted features from the individual and multiple application events and other parameters may be stored locally in memory 312 or remotely in storage device(s) 220 or database 118, for example. The model training engine 336 receives the extracted features and includes processor-executable instructions to build and train models using the extracted features from the individual and multiple application events along with other parameters. By training the models, the models learn the normal way in which an entity interacts with the application 350. The trained models are used in the detection of abnormal behavior from one or more entities. The trained models may be stored locally in memory 312 or remotely in storage device(s) 220 or database 118, for example.

The batch anomaly generator 340 includes processor-executable instructions to identify anomalies during a batch process. Generally, anomalies tend to he rather infrequent given the volume of data in the application events 352. As used herein, anomalies are generated when a successfully trained model detects abnormal behavior from an entity. Some examples of anomalies may include but are not limited to the following examples. When an entity runs an application that is not run by any other entity in an entity peer group in which the entity belongs, an anomaly is generated. When an entity interacts with an entity that the entity does not normally interact with, an anomaly is generated. When an entity logs in from a location (e.g., a country) the entity does not normally log in from, an anomaly is generated.

In addition, identified anomalies are characterized by, but are not limited to, the following: timestamp of the anomaly; entities associated with the anomalies; probability of the prediction from the trained models; risk/severity of the anomaly; details about the anomaly context; raw data associated with the anomaly; and other information relevant to the anomaly that varies between trained models. Referring back to FIG. 5A, the trained models may be successfully trained to predict that Bob logged in from the U.S. which is a location that Bob does not normally log in from, as indicated in application event No. 3.

The batch risk score engine 344 includes processor-executable instructions that use the anomalies identified by the batch anomaly generator 340 to generate a risk score for an entity during a batch process. The batch risk score can be stored locally in memory 312 or remotely in storage device(s) 220 or database 118, for example. Some of the outputs from the various components of the batch components 320 are used as inputs for some of the various components of the NRT components 324.

FIG. 3C is a block diagram illustrating example elements for the NRT components 324 included in the example data analytics in near real-time system 304 in which embodiments of the present disclosure may be implemented. The NRT components 324 include NRT feature extractor 360, NRT anomaly generator 364 and NRT risk score engine 368. At any moment in time after the batch process has been completed and a batch risk score has been generated, the NRT feature extractor 360 includes processor-executable instructions that receive and process application events 352 from the application 350. These application events 352, however, are application events that occur in near real-time.

According to embodiments of the present disclosure, the NRT feature extractor 360 receives the application events 352 (e.g., application events similar to application events illustrated in FIG. 5A but generated in near real-time) and processes the application events 352 by extracting features from the individual application events 352. Extracted features from the individual application events 352 may include extracted features similar to the extracted features illustrated in FIG. 5B. The NRT anomaly generator 364 includes processor-executable instructions that identify NRT anomalies based on NRT features extracted from the individual application events 352, the trained models trained by the model training engine 336 and other parameters. The NRT risk score engine 368 includes processor-executable instructions that generate a NRT risk score based on the NRT anomalies identified by the NRT anomaly generator 364 and the batch risk score computed by the batch risk score engine 344. The NRT risk score may be stored locally in memory 312 or the NRT risk score 342 may be transmitted and stored remotely in storage device(s) 220 or database 118.

The NRT risk score is compared with a predetermined threshold to determine if the NRT risk score exceeds the predetermined threshold. If the NRT risk score exceeds the predetermined threshold, a set of actions may be implemented for an entity authentication system or an alert notification system. Actions implemented for the entity authentication system may include determining if additional information or checks are warranted for authenticating an entity. Actions implemented for the alert notification system may include alerts that are automatically implemented, for example, at the server(s) 114, 116, that are directed towards the anomalies. When the alerts cannot be automatically implemented, for example, because they require human intervention, the data analytics in near real-time system 304 can transmit messages to concerned personnel. The transmissions of the alerts may include but are not limited to, emails, SMS (Small Message Service), IMs (Instant Messages), automated phone calls and the like and may include details regarding the anomalies and their severities. Referring back to FIG. 3C, the near real-time risk score is used for entity authentication 390 or alert notification 380. According to an alternative embodiment of the present disclosure, if the NRT risk score exceeds the predetermined threshold, an action may include displaying one or more of the batch risk scores, the NRT risk scores, batch anomalies or NRT anomalies on the GUI 370.

According to embodiments of the present disclosure, the NRT risk score engine 368 is designed to handle at least three scenarios. A first scenario includes the features related to User 1. User 1 is active (e.g., using application 350) on the current day. A NRT risk score is generated for User 1 based on an existing NRT risk score, the stats (e.g., the number of days) and the provided login event (e.g., application events 352) for User 1. A second scenario includes the features related to User 2. There are no application events 352 for the current day for User 2. A NRT risk score is generated for User 2 based on an existing batch score, the stats (e.g., the number of days) and the provided login event (application event 352) for User 2. A third scenario includes the features related to User 3. User 3 has never used the application 350. Therefore, there is no historical data for User 3. A NRT risk score is generated based on a default starting score and the provided login event (e.g., application event 352) for User 3.

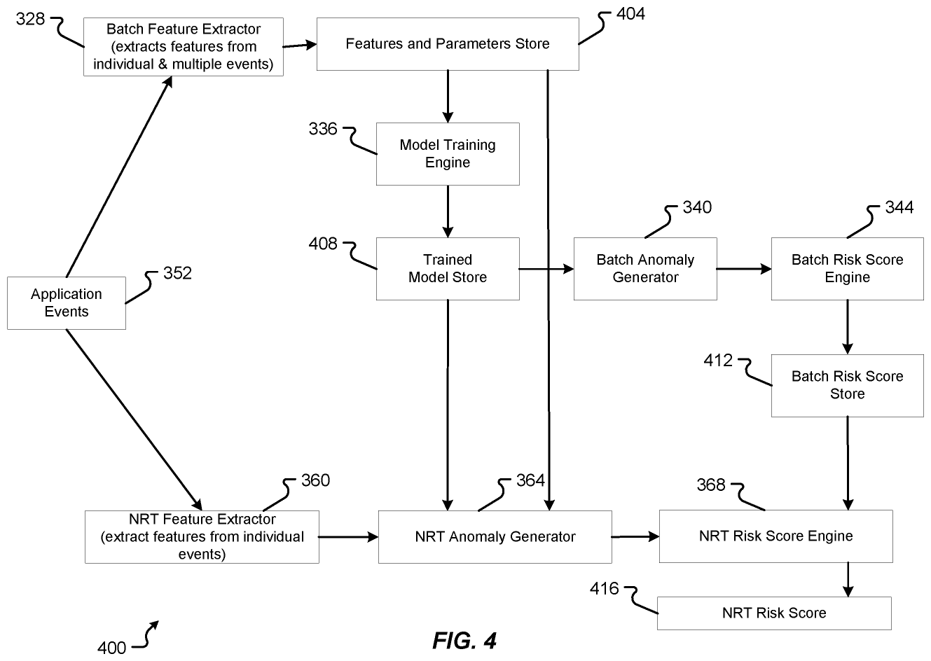

FIG. 4 is a block diagram illustrating elements of an example data analytics in near real-time system architecture 400 according to embodiments of the present disclosure. The data analytics in near real-time system architecture 400 includes similar elements as those illustrated in FIGS. 3B and 3C. Since these elements are discussed in FIGS. 3B and 3C, a description of these elements will be omitted. As illustrated in the data analytics in near real-time system architecture 400, application events 352 are processed by each of the batch feature extractor 328 and the NRT feature extractor 360. The batch feature extractor 328 extracts features from individual application events and extracts features from multiple application events during a batch process. The NRT feature extractor 360 extracts features from individual application events in near real-time. After the features are extracted by the batch feature extractor 328, the features are stored in the features and parameters store 404. Although the features and parameters store 404 is illustrated as these components being stored together, these components, however, may be stored separately. The model training engine 336 uses the extracted features to build and train models. These trained models are stored in the trained model store 408. The stored trained models are used by the batch anomaly generator 340 to identify anomalies during the batch process. The identified anomalies from the batch anomaly generator 340 are used by the batch risk score engine 344 to generate a batch risk score which is stored in the batch risk score store 412.

At any moment in time after the batch process has been completed and a batch risk score has been generated, the NRT feature extractor 360 receives application events 352 in near real-time for feature extraction. After the features have been extracted by the NRT feature extractor 360, the NRT anomaly generator 364 identifies NRT anomalies based on NRT features extracted from the application events 352, the trained models trained by the model training engine 336 and other parameters. The NRT risk score engine 368 generates a NRT risk score based on the NRT anomalies identified by the NRT anomaly generator 364 and the batch risk score computed by the batch risk score engine 344. According to embodiments of the present disclosure, the NRT risk score is used for entity authentication 390 or alert notification 380.

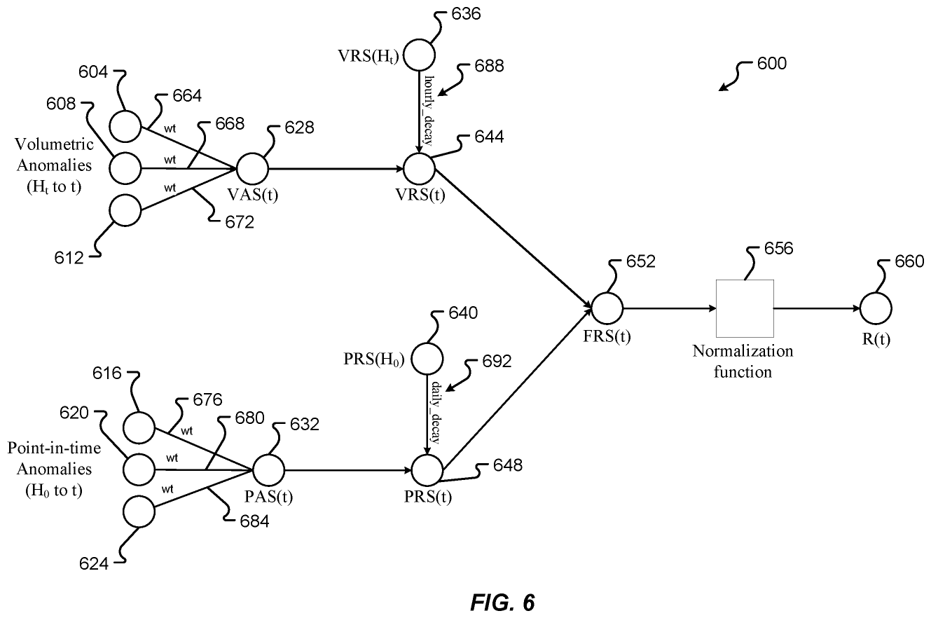

FIG. 6 is a graph 600 illustrating an example NRT risk score engine for the example data analytics in near real-time system 304 according to embodiments of the present disclosure. As illustrated in FIG. 6, the graph 600 includes volumetric anomalies 604-612 from time Hₜ to t, point-in-time anomalies 616-624 from time H₀ to t, the weighted sum of the volumetric anomalies at time t (VAS(t)) at 624, the weighted sum of the point-in-time anomalies at time t (PAS(t)) at 632, the sum of the contributions from both the weighted volumetric anomalies and the weighted point-in-time anomalies at time t (FRS(t)) at 652, a normalization function at 656 and a risk score at time t (R(t)) at 660. As defined herein “t” represents the current time, “Hₜ” represents the current time rounded to the present hour and “H₀” represents the first hour of each day. For example, if the current time t is 9:26 a.m., then Hₜ is 9:00 a.m. Likewise, if the current time t is 9:56 a.m., then Hₜ is still 9:00 a.m. According to embodiments of the present disclosure, the first hour of the day H0 is set to 12:00 a.m. Although 12:00 a.m. is selected as the first hour of the day, any hour can be selected as the first hour of the day without departing from the spirit and scope of the present disclosure.

The volumetric anomalies 604-612 are anomalies that are generated based on hourly volumes (aggregated events). Contributions of these anomalies to the risk score remain the same throughout the hour and decay the next hour. The point-in-time anomalies 616-624 are anomalies generated per event. Contributions of these anomalies to the risk score remain the same throughout the day and decay the next day. Each of the volumetric anomalies 604-612 and the point-in-time anomalies 616-624 are assigned a weight 664-684 (e.g., a weight factor) based on the contribution to the system.

The weighted volumetric anomalies 604/664, 608/668 and 612/672 are summed at time t (VAS(t)) at 628. The weighed sums of the volumetric anomalies at time t (VAS(t)) at 628 are added to volumetric anomalies up to the present hour Hₜ VRS(Hₜ) at 636 to generate at time t, the sum VRS(t) at 644. These volumetric anomalies up to the present hour Hₜ are scaled at a rate at which the value of VRS(Hₜ) decays after one hour (e.g., scaled at an hourly decay 688). Although one hour is selected as the time frame at which the rate of decay is determined, other values other than one hour can be used without departing from the spirit and scope of the present disclosure.

The weighted point-in-time anomalies 616/676, 620/680 and 624/684 are summed at time t (PAS(t)) at 632. The weighed sums of the point-in-time anomalies at time t (PAS(t)) at 632 are added to point-in-time anomalies up to the first hour of the day H₀ (PRS(H₀) at 640 to generate at time t the sum PRS(t) at 648. These point-in-time anomalies up to the first hour of the day H₀ are scaled at a rate at which the value of PRS(H₀) decays in one day (e.g., scaled at a daily decay 692). Although one day is selected as the time frame at which the rate of decay is determined, other values other than one day can be used without departing from the spirit and scope of the present disclosure.

VRS(t) at 644 (e.g., the weighed sums of the volumetric anomalies at time t (VAS(t)) at 628 and the volumetric anomalies up to the present hour Hₜ VRS(Hₜ) at 636) and PRS(t) at 648 (e.g., the weighed sums of the point-in-time anomalies at time t (PAS(t)) at 632 and the point-in-time anomalies up to the first hour of the day H₀ (PRS(H₀) at 640) are added together at 652. This sum of the contributions from both the volumetric anomalies and point-in-time anomalies at time t (FRS(t)) at 652 is normalized by normalization function at 656. The normalization function normalizes FRS(t) to a risk score between 0 and 100. After FRS(t) has been normalized at 656, a risk score R(t) is generated at time t at 660.

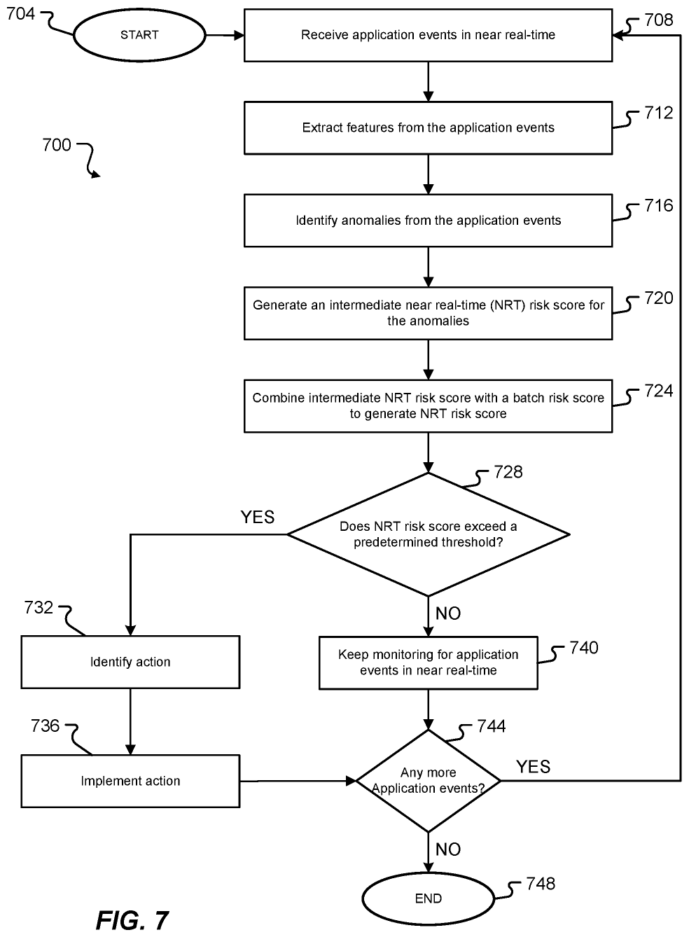

FIG. 7 is a flowchart illustrating an example method 700 for near real-time risk score generation for entity authentication 390 or alert notification 380 according to embodiments of the present disclosure. While a general order of the steps of method 700 is shown in FIG. 7, method 700 can include more or fewer steps or can arrange the order of the step differently than those shown in FIG. 7. Further, two or more steps may be combined in one step. Generally, the method 700 starts with a START operation at step 704 and ends with an END operation at step 748. The method 700 can be executed as a set of computer-executable instructions executed by a computer system (e.g., data analytics in near real-time system 304, the processor 306, etc.) and encoded or stored on a computer readable medium. Hereinafter, the method 700 shall be explained with reference to the systems, components, modules, applications, software, data structures, user interfaces, etc. described in conjunction with FIGS. 1-6 and 9.

Method 700 begins with START operation at step 704 and proceeds to step 708, where the processor 306 of the data analytics in near real-time system 304 receives application events 352 in near real-time. Application events 352 are received during the course of execution of the application 350. For example, if the application 350 is a web-based eCommerce application, the application events 352 may comprise information or data from the hardware executing the application, information from entity sessions including log information, data retrieved, transactions conducted, database connectivity, network performance and the like.

After receiving the application events 352 in near real time at step 708, method 700 proceeds to step 712, where the processor 306 and the NRT feature extractor 360 of the data analytics in near real-time system 304 extract features from the application events 352. After the processor 306 and the NRT feature extractor 360 of the data analytics in near real-time system 304 extract features from the application events 352 at step 712, method 700 proceeds to step 716, where the processor 306 and the NRT anomaly generator 364 of the data analytics in near real-time system 304 identify anomalies from the application events 352. In order to identify anomalies, the NRT anomaly generator 364 uses the extracted features from the NRT feature extractor 360 along with trained models and additional parameters. The trained models are trained with extracted features from individual and multiple application events, extracted during a batch process performed prior to receiving the application events 352 in near real-time. After the processor 306 and the NRT anomaly generator 364 of the data analytics in near real-time system 304 identify anomalies from the application events 352 at step 716, method 700 proceeds to step 720, where the processor 306 and the NRT risk score generator 368 of the data analytics in near real-time system 304 generate an intermediate NRT risk score. After the processor 306 and the NRT risk score generator 368 of the data analytics in near real-time system 304 generate an intermediate NRT risk score, at step 720, method 700 proceeds to step 724, where the processor 306 and the NRT risk score generator 368 of the data analytics in near real-time system 304 generate a NRT risk score. This risk score combines the intermediate NRT risk score with the batch risk score to produce the NRT risk score. After the processor 306 and the NRT risk score generator 368 of the data analytics in near real-time system 304 generate a NRT risk score at step 724, method 700 proceeds to decision step 728, where the processor 306 of the data analytics in near real-time system 304 determines if the NRT risk score exceeds a predetermined threshold. If the NRT risk score exceeds the predetermined threshold (YES) at decision step 728, method 700 proceeds to step 732, where the processor 306 of the data analytics in near real-time system 304 identifies an action. The identified action may include action(s) for entity authentication 390 or action(s) for alert notification 380. After the processor 306 of the data analytics in near real-time system 304 identifies an action at step 732, method 700 proceeds to step 736, where the processor 306 of the data analytics in near real-time system 304 implements the action.

After the processor 306 of the data analytics in near real-time system 304 implements the action at step 736, method 700 proceeds to decision step 744, where the processor 306 of the data analytics in near real-time system 304 determines if there are any more application events 352. If there are no more application events 352 (NO) at decision step 744, method 700 ends with END operation at step 748. If there are more application events 352 (YES) at decision step 744, method 700 returns to step 708. If the NRT risk score does not exceed the predetermined threshold (NO) at decision step 728, method 700 proceeds to step 740, where the processor 306 of the data analytics in near real-time system 304 keeps monitoring for application events 352 in near real-time. After the processor 306 of the data analytics in near real-time system 304 keeps monitoring for application events 352 in near real-time at step 740, method 700 returns to decision step 744, where the processor 306 of the data analytics in near real-time system 304 determines if there are any more application events 352. If there are no more application events 352 (NO) at decision step 744, method 700 ends with END operation at step 748 and if there are more application events 352 (YES) at decision step 744, method 700 returns to step 708.

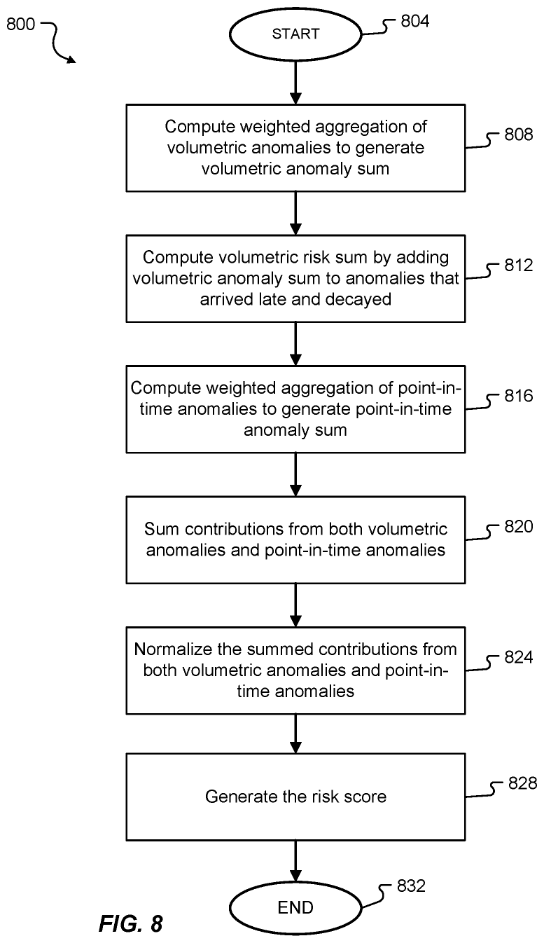

FIG. 8 is a flowchart illustrating an example method 800 of near real-time risk generation according to embodiments of the present disclosure. While a general order of the steps of method 800 is shown in FIG. 8, method 800 can include more or fewer steps or can arrange the order of the step differently than those shown in FIG. 8. Further, two or more steps may be combined in one step. Generally, the method 800 starts with a START operation at step 804 and ends with an END operation at step 832. The method 800 can be executed as a set of computer-executable instructions executed by a computer system (e.g., data analytics in near real-time system 304, the processor 306, etc.) and encoded or stored on a computer readable medium. Hereinafter, the method 800 shall be explained with reference to the systems, components, modules, applications, software, data structures, user interfaces, etc. described in conjunction with FIGS. 1-6 and 9.

Method 800 begins with START operation at step 804 and proceeds to step 808, where the processor 306 of the data analytics in near real-time system 304 computes a weighted aggregation of volumetric anomalies to generate a volumetric anomaly sum. After generating the volumetric anomaly sum at step 808, method 800 proceeds to step 812, where the processor 306 of the data analytics in near real-time system 304 computes the volumetric risk sum by adding the volumetric anomaly sum to anomalies that arrived late and decayed. After computing the volumetric risk sum at step 812, method 800 proceeds to step 816, where the processor 306 of the data analytics in near real-time system 304 computes the weighted aggregation of point-in-time anomalies to generate the point-in-time anomaly sum. After generating the point-in-time anomaly sum at step 816, method 800 proceeds to step 820, where the processor 306 of the data analytics in near real-time system 304 sums the contributions from both the volumetric anomalies and the point-in-time anomalies. After the contributions from both the volumetric anomalies and the point-in-time anomalies are summed at step 820, method 800 proceeds to step 824, where the processor 306 of the data analytics in near real-time system 304 normalizes the summed contributions from both the volumetric anomalies and the point-in-time anomalies. After the summed contributions of both the volumetric anomalies and the point-in-time anomalies are normalized at step 824, method 800 proceeds to step 828, where the processor 306 of the data analytics in near real-time system 304 generates the risk score. After the risk score has been generated at step 828, method 800 ends with END operation at step 832.

Any of the steps, functions, and operations discussed herein can be performed continuously and automatically.

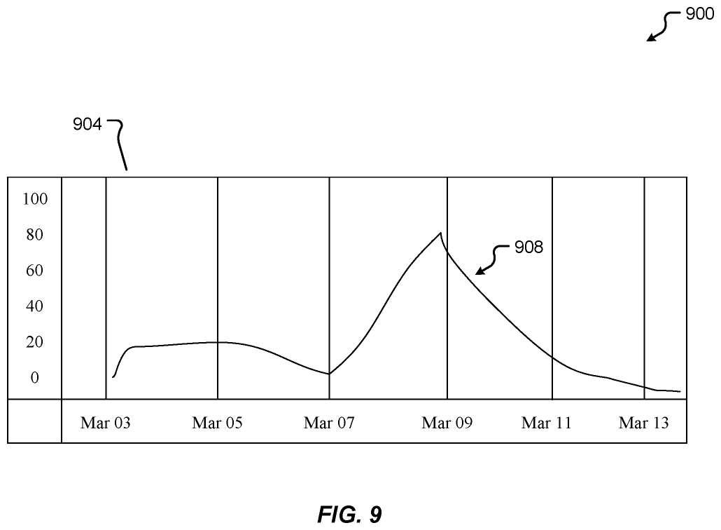

FIG. 9 is an example graphical user interface (GUI) 900 associated with the example data analytics in near real-time system 304 according to embodiments of the present disclosure. The GUI 900 includes a graph 904 illustrating an example near real-time risk score curve 908 for an entity. The y-axis represents the risk scores and the x-axis represents dates in increments of unit time, where the unit time refers to days, hours, minutes, seconds, etc. As illustrated in FIG. 9, an entity has a risk score between 10 and 20 from Mar. 3, 2022 to Mar. 7, 2022, a risk score of 80 around Mar. 9, 2022 and a risk score of less than 20 from Mar. 11, 2022 to Mar. 13, 2022. The example near real-time risk score curve 908 provides valuable information in determining if alerts need to be generated or if additional information is required for entity authentication 390 purposes. With a risk score of 80 around Mar. 9, 2022, the data analytics in near real-time system 304 would most likely generate alerts or require additional information for entity authentication 390 purposes.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-processors, ARM® Cortex-A and ARM926EJ-S™ processors, other industry-equivalent processors, and may perform computational functions using any known or future-developed standard, instruction set, libraries, and/or architecture.

Any of the steps, functions, and operations discussed herein can be performed continuously and automatically.

However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A system, comprising:
a processor; and
a memory coupled with and readable by the processor and storing therein a set of instructions which, when executed by the processor, causes the processor to generate risk scores in near real-time by:
receiving near real-time application events associated with an application in near real-time;
identifying anomalies from the near real-time application events;
generating an intermediate near real-time risk score for the identified anomalies; and
combining the intermediate near real-time risk score with a batch risk score generated from a batch process executed prior to receiving the near real-time application events to generate a near real-time risk score.

2. The system of claim 1, wherein identifying anomalies from the near real-time application events further comprises extracting features from each near real-time application at one time.

3. The system of claim 1, wherein identifying anomalies from the near real-time application events further comprises using models trained from extracted features from application events processed during the batch process.

4. The system of claim 3, wherein the extracted features from application events processed during the batch process include features extracted from each application event at one time and features extracted from multiple application events at one time.

5. The system of claim 1, wherein the identified anomalies include volumetric anomalies and point-in-time anomalies.

6. The system of claim 5, wherein some of the volumetric anomalies are subject to a time dependent decay in value.

7. The system of claim 5, wherein some of the point-in-time anomalies are subject to a time dependent decay in value.

8. The system of claim 1, further comprising:
comparing the near real-time risk score with a predetermined threshold; and
initiating an action if near real-time risk score exceeds the predetermined threshold.

9. The system of claim 8, wherein initiating an action if the near real-time risk score exceeds the predetermined threshold further comprises requesting additional information for entity authentication.

10. The system of claim 8, wherein initiating an action if the near real-time risk score exceeds the predetermined threshold further comprises requesting a detailed investigation in response to an alert notification.

11. The system of claim 8, wherein initiating an action if the near real-time risk score exceeds the predetermined threshold further comprises displaying a graphical representation of the near real-time risk score.

12. A method for generating risk scores in near real-time, the method comprising:
receiving, by a data analytics in near real-time system, near real-time application events associated with an application of the data analytics in near real-time system in near real-time;
identifying, by the data analytics in near real-time system, anomalies from the near real-time application events;
generating, by the data analytics in near real-time system, an intermediate near real-time risk score for the identified anomalies; and
combining, by data analytics in near real-time system, the intermediate near real-time risk score with a batch risk score generated from a batch process executed prior to receiving the near real-time application events to generate a near real-time risk score.

13. The method of claim 12, wherein identifying anomalies from the near real-time application events further comprises extracting, by the data analytics in near real-time system, features from each near real-time application at one time.

14. The method of claim 12, wherein identifying anomalies from the near real-time application events further comprises using, by the data analytics in near real-time system, models trained from extracted features from application events processed during the batch process.

15. The method of claim 14, wherein the extracted features from application events processed during the batch process include features extracted from each application event at one time and features extracted from multiple application events at one time.

16. The method of claim 12, wherein the identified anomalies include volumetric anomalies and point-in-time anomalies.

17. The method of claim 16, wherein some of the volumetric anomalies are subject to a time dependent decay in value.

18. The method of claim 16, wherein some of the point-in-time anomalies are subject to a time dependent decay in value.

19. The method of claim 12, further comprising:
comparing, by the data analytics in near real-time system, the near real-time risk score with a predetermined threshold; and
initiating, by the data analytics in near real-time system, an action if the near real-time risk score exceeds the predetermined threshold.

20. A non-transitory, computer readable medium comprising a set of instructions stored therein which when executed by a processor, causes the processor to generate risk scores in near real-time by:
receiving near real-time application events associated with an application in near real-time;
identifying anomalies from the near real-time application events;
generating an intermediate near real-time risk score for the identified anomalies; and
combining the intermediate near real-time risk score with a batch risk score generated from a batch process executed prior to receiving the near real-time application events to generate a near real-time risk score.
